(19) United States
(12) Patent Application Publication
(10) Pub. No.: US 2012/0313543 A1
(43) Pub. Date: Dec. 13, 2012

(54) TRANSFORMER AS WELL AS SWITCHING POWER SUPPLY AND LED FLUORESCENT LAMP APPLYING SAME

(76) Inventors: Deqi Zhao, Shenzhen (CN); Ying Li, Shenzhen (CN)

(21) Appl. No.: 13/578,032

(22) PCT Filed: Jun. 7, 2010
(86) PCT No.: PCT/CN10/73605

§ 371 Date: Aug. 9, 2012

(30) Foreign Application Priority Data
May 26, 2010 (CN) 201010184246.0

(51) Int. Cl. H01F 27/28; H05B 37/02; H01F 27/24

(52) U.S. Cl. 315/224; 336/221

(57) ABSTRACT

A transformer as well as a switching power supply and a LED fluorescent lamp applying the same. The transformer comprises: a framework (1), a magnetic core (2) and a winding (3). A reel (10) of the framework (1) is in a hollow column structure with openings at two ends. Lateral walls of the framework extend vertically at the openings at two ends to form an annular slot structure (11). The winding (3) is wound around the annular slot structure (11). The magnetic core is in a structure as Chinese character Ri openings at two ends which covers the reel (10) and the winding (3) from the circumference. The middle part of the magnetic core (2) is inserted into the reel (10). The transformer as well as the switching power supply and the LED fluorescent lamp applying the same has better electromagnetic compatibility, reducing EMI to other devices and power grids.

### FIELD OF THE INVENTION

The exemplary invention relates to electronic applications, and particularly to a transformer as well as a switching power supply and a LED (light emitting diode) fluorescent lamp applying the transformer.

### BACKGROUND OF THE INVENTION

Electromagnetic interference (EMI) is disturbance that affects an electrical circuit due to either electromagnetic induction or electromagnetic radiation usually emitted from electromagnetic radiation sources, such as motors, transformers, and the EMI is an electrical noise which can interfere with electrical signals and reduce the integrity of signals. Since the noise reduction technology of electronic systems appears in the mid-1970s, the Federal Communications commission (FCC) in 1990 and the European Union (EU) in 1992 enacted and issued relevant rules and regulations for electronic products, which requires that companies should ensure their products must meet magnetic susceptibility and emission criteria. The products complying with the relevant rules and regulations have the capacity of electromagnetic compatibility (EMC).

The EMI has two kinds of interferences including conducted interference and radiated interference. The conducted interference means that the signals of an electric network are coupled (or interfered) to another electric network through conductive medium with the interference frequency of 9 KHz-30 MHz. The radiated interference means that the signals of an interference source are coupled (or interfered) to an electric network with the interference frequency of 30 MHz-300 MHz through space (e.g., atmosphere) according to the laws of electromagnetic wave propagation.

In the design of printed circuit board (PCB) and system, high-frequency signal wires, pins of integrated circuits (ICs) and different kinds of connectors may be considered as radiation interference source with the antennas characteristics. And the radiation interference source can radiate electromagnetic waves which may result in abnormal work of other systems or other subsystems of this system. During above all mentioned conditions causing EMI to other devices and power grids, the transformer is one of the most important elements which can not be ignored.

However, in the specific implementation process, since the existing electronic devices equipped with various transformers are usually limited by their size and power, the EMC of the transformers often fails to meet the required standards, therefore resulting in heavy EMI to other device and power grids.

Therefore, there is room for improvement within the art.

### DISCLOSURE OF THE INVENTION

The present invention is to provide a transformer as well as a switching power supply and a LED fluorescent lamp applying the transformer. The transformer can provide the maximum power, but with the smallest size, and has better electromagnetic compatibility, therefore it has greatly reduced EMI to other devices and power grids. The transformer includes a framework 1, a magnetic core 2 and a winding 3. The framework 1 includes a reel 10 in a hollow column structure with openings at two ends, and lateral walls of the reel 10 extend vertically at the position of the openings at two ends to form an annular slot structure 11. The winding 3 is wound around the annular slot structure 11. The magnetic core 2 is a [symbol] shaped box structure with openings at two ends and covers the reel 10 and the winding 3 from circumference, and the middle part of the magnetic core 2 is inserted into the hollow reel 10.

The reel 10 is a flat and hollow structure with openings at two ends.

The transformer further comprises a plurality of pins 12 fixed on one end of the reel 10, and the pins 12 are extended out of the opening of the magnetic core 2 and are electrically connected to the winding 3.

The magnetic core 2 comprises two magnets with “E” shaped cross-section, the middle part of one magnet is inserted through one opening of the reel 10, and the middle part of another magnet is inserted through the other opening of the reel 10, and the two middle parts are jointed to each other in the hollow reel 10 to form the magnetic core 2 with a “ [symbol] ” shaped cross-section and with openings at two ends.

The magnetic core 2 with a “ [symbol] ” shaped box structure and with openings at two ends gradually tightens inwards from the openings at two ends to narrow the area of the openings.

The framework 1 is made from insulating materials comprising Bakelite, rubber, plastic, glass, ceramics, glass fiber and nylon.

The two magnetic cores 2 are composed of two magnets, and the two magnets are adhered together by filling up adhesion substance or are tied together, and the adhered or tied two magnets are fixed on the framework 1.

The winding 3 is bonded together by means of adhesion substance and is wound around the annular slot structure 11.

The present invention further provides a switching power supply applied to a light emitting diode (LED) fluorescent lamp. The switching power supply is built-in the LED fluorescent lamp. The switching power supply includes a transformer.

The present invention further provides a light emitting diode (LED) fluorescent lamp, the LED fluorescent lamp includes the switching power supply.

Using the transformer as well as the switching power supply and LED fluorescent lamp applying the transformer of the present invention, the transformer with the smallest size can also provide the maximum power. The transformer is a “matchbox” shaped structure due to the magnetic core packaged by the framework and the windings. So that the interference generated by high-frequency current flowing through the winding is shielded and insulated by the “matchbox” shaped magnetic core, therefore it can solve the problem of electromagnetic interference in the effective space. The transformer has better electromagnetic compatibility, thereby greatly reducing EMI to other devices and power grids.

Other advantages and novel features of the present disclosure will become more apparent from the following detailed description of preferred embodiment when taken in conjunction with the accompanying drawings.

### BRIEF DESCRIPTION OF THE DRAWINGS

FIGS. 1A and 1B are structural schematic views of a traditional transformer.

FIG. 2 is an exploded schematic view of a transformer according to one embodiment of this disclosure.

FIG. 3 is an assembled schematic view of the transformer shown in FIG. 2.

FIGS. 4A, 4B, 4C, 4D and 4E are exploded views from different angles of the transformer.

FIG. 5 is a schematic view of a light emitting diode (LED) fluorescent lamp according to one embodiment of this disclosure.

FIG. 6 is a structural schematic view of a common switching power supply.

FIG. 7 is a structural schematic view of a switching power supply applied to the LED fluorescent lamp according to one embodiment of this disclosure.

### DETAILED DESCRIPTION OF ILLUSTRATED EMBODIMENTS

The following drawings are used here for the purpose to more clearly illustrate and understand the embodiments of the present invention.

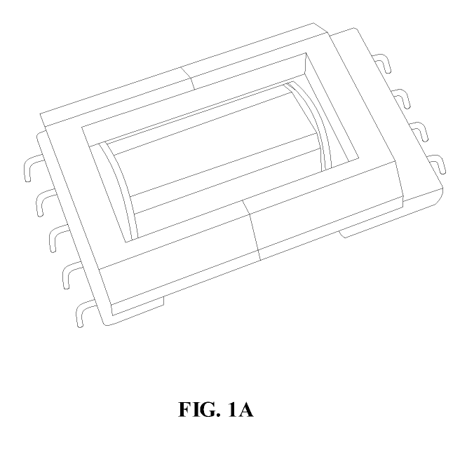

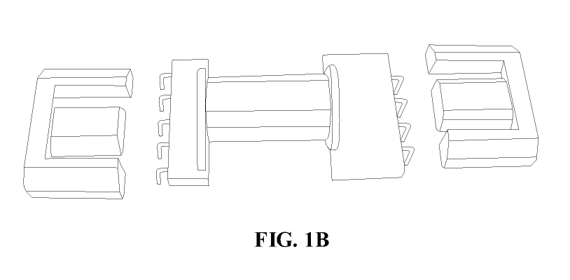

FIGS. 1A and 1B are structural schematic views of a traditional transformer, FIG. 1A is an assembled view of the transformer, and FIG. 1B is an exploded view of the transformer. In this traditional transformer, referring to FIGS. 1A and 1B, most of windings are exposed to air, so that when the transformer is in a working state, the electromagnetic waves from the transformer can be radiated to external without shield and insulation, which is an important factor to produce electromagnetic interference (EMI). Moreover, in this traditional transformer, the winding is wound around a magnetic core, and the cross-sectional area of the magnetic core wound by the winding is small, which may cause the power of the transformer to be a lower value.

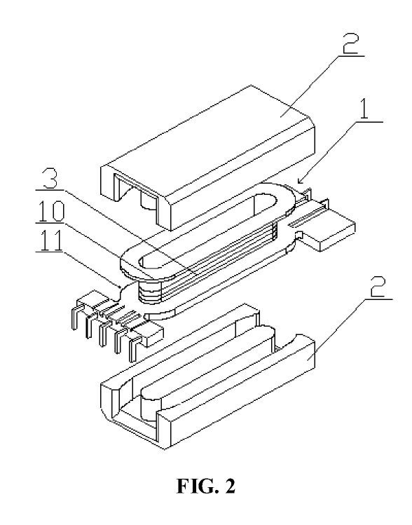

The present invention provides a transformer which can solve the above problems. Referring to FIG. 2, the transformer includes a framework 1, a magnetic core 2, and a winding 3. The framework 1 includes a reel 10, and the reel 10 is a hollow column structure with openings at two ends. Lateral walls of the reel 10 extend vertically at the position of the openings at two ends to form an annular slot structure 11. The winding 3 is wound around the annular slot structure 11. The magnetic core 2 is in a structure as Chinese character Ri (i.e., a “ [symbol] shaped box structure) with openings at two ends and covers the reel 10 and the winding 3 from circumference. The middle part of the magnetic core 2 is inserted into the hollow reel 10. The magnetic core 2 gradually tightens inwards from its openings at two ends to narrow the area of the openings, to further reduce exposed area of the winding 3 to achieve a better shielding effect.

Furthermore, the reel 10 is a flat and hollow column structure with openings at two ends. For example, if the reel 10 is a hollow cylinder, the height of the hollow cylinder should be less than the diameter of the cylinder; if the reel 10 is a hollow cubic column (e.g., cuboid), the height of the hollow cubic column should be less than the length of a side of the bottom surface of the cubic column

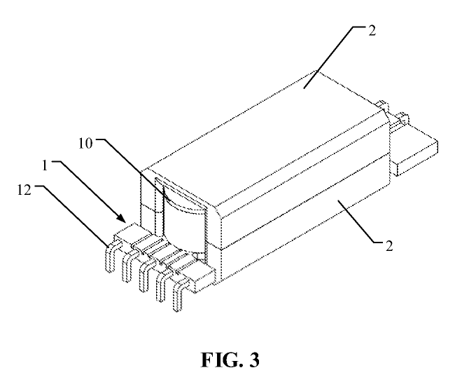

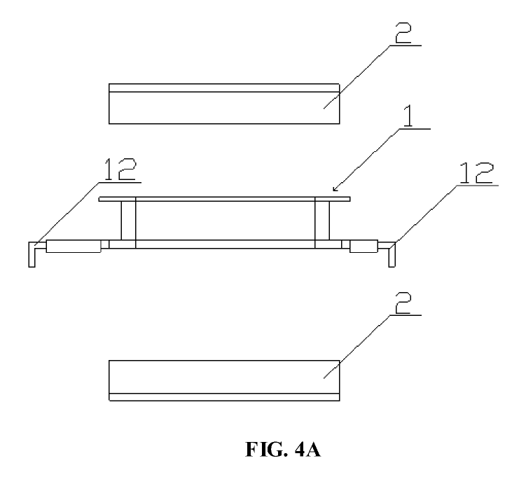

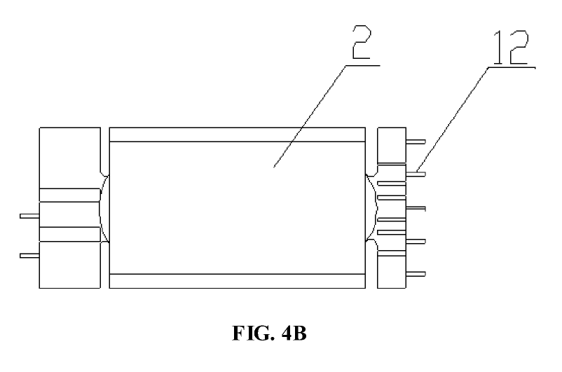

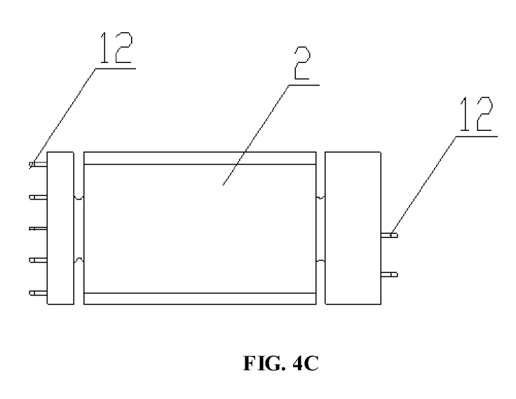

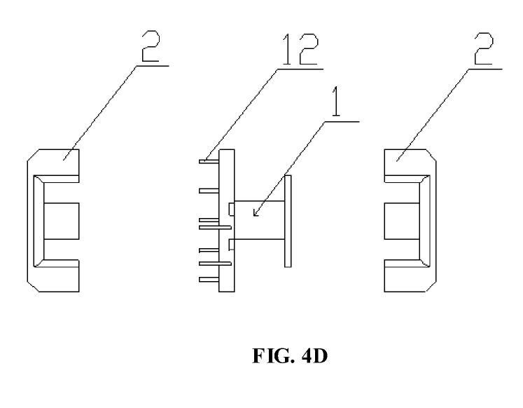

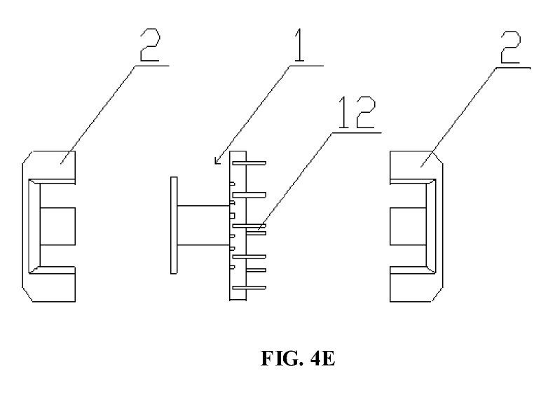

FIGS. 3 and 4 are used here to more detailedly illustrate the transformer structure of the present invention. FIG. 3 is an assembled schematic view of the transformer. FIGS. 4A, 4B, 4C, 4D and 4E are exploded views from different angles of the transformer. The transformer includes a framework 1, a magnetic core 2, and a winding 3. The framework 1 includes a reel 10, and the reel 10 is a hollow column structure with openings at two ends. Lateral walls of the reel 10 extend vertically at the position of the openings at two ends to form an annular slot structure 11. The winding 3 is wound around the annular slot structure 11. The magnetic core 2 is in a box structure with a “ [symbol] ” shaped cross-section and with openings at two ends, and covers the reel 10 and the winding 3 from circumference. The middle part of the magnetic core 2 is inserted into the hollow reel 10.

Moreover, the reel 10 is a hollow column structure with openings at two ends and includes a hollow cylinder and a plurality of prisms (no labeled). It should be noted that, in the present invention, the height of any of the hollow column structures is less than the width or the diameter of the hollow column structure. Thus, in this embodiment, when the magnetic core 2 is inserted into and passes through the reel 10, the cross-sectional area of the magnetic core 2 passing through the reel 10 is greater than the cross-sectional area that the magnetic core is wound by the winding of the traditional transformer. Thus, even through the traditional transformer and the transformer of the present invention have the same size, the transformer of the present invention has a higher power than that of the traditional transformer.

Preferably, the transformer of this embodiment further includes a plurality of pins 12 fixed on one end of the reel 10. The pins 12 are extended out of the opening of the magnetic core 2, and are electrically connected to the winding 3.

More specifically, in this embodiment, the magnetic core 2 includes two magnets with “E” shaped cross-section. The middle part of one magnet is inserted through one opening of the reel 10, and the middle part of another magnet is inserted through the other opening of the reel 10. Thus, the two middle parts are jointed to each other in the hollow reel 10, forming the magnetic core 2 with a closed box structure.

The magnetic core 2 includes a housing whose shape is about a rectangle with openings at two ends. A magnet is positioned within the magnetic core 2 and passes through the hollow magnetic core 2, and the shape of the magnet matches the hollow part of the magnetic core 2. The magnetic core 2 is wound around the framework 1 and winding 3, forming a “matchbox” shaped structure and only leaving a little open space at two ends for extension of the framework 1 and wiring of the winding 3. Thus, high-frequency current flows through the winding 3 and generates the interference, and the interference is shielded by the “matchbox” shaped magnetic core 2 and cannot be radiated to the outside, thus effectively reducing the electromagnetic interference.

More specifically, the framework 1 is made from insulating materials, such as bakelite, rubber, plastic, glass, ceramics, glass fiber and nylon. The two magnets of the magnetic core 2 are adhered together by filling up adhesion substance between each other, or are tied together, then the adhered or tied two magnets are fixed on the framework 1. The winding 3 is bonded together by means of adhesion substance, such as glue, and is wound around the annular slot structure 11.

The transformer of this embodiment in the present invention can provide the maximum power, but with the smallest size. Because the magnetic core is wound around the framework and winding, forming “matchbox” shaped structure and only leaving a little open space at two ends for extension of the framework and wiring layout of the winding. Thus, the interference generated by high-frequency current flowing through the winding is shielded and insulated by the “matchbox” shaped magnetic core, therefore solving the problem of electromagnetic interference in the effective space. The transformer has better electromagnetic compatibility, thereby greatly reducing EMI to other devices and power grids.

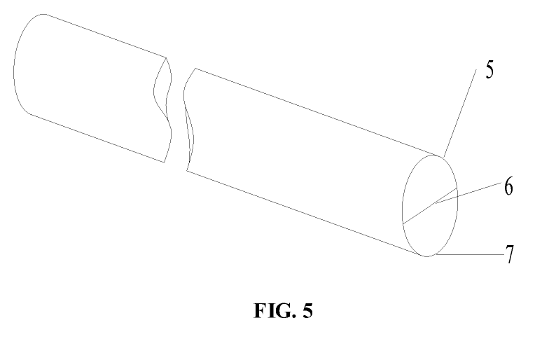

The transformer of the present invention is especially applied to a switching power supply of a light emitting diode (LED) fluorescent lamp. FIG. 5 is a schematic view of the LED fluorescent lamp according to one embodiment of this disclosure.

The LED fluorescent lamps are gradually replacing the existing fluorescent lamps. In order to replace or be compatible with the existing mercury fluorescent lamps, the size of the LED fluorescent lamp is as far as possible close to the size of the existing mercury fluorescent lamps, but the principle of the LED fluorescent lamp is completely different from that of the mercury fluorescent lamp. Referring to FIG. 5, the LED fluorescent lamp includes a semicircular aluminum extruded section 5, a semicircular transparent or translucent polycarbonate (PC) material tube 6, and a printed circuit board (PCB) 7. A group of LED lamps including 200-300 LED lamps is positioned on and electrically connected to the PCB 7. The aluminum extruded section 5 and the PC material tube 6 are engaged with each other, therefore cooperatively forming a round tube which has the same shape as the existing mercury fluorescent lamp. The PCB 7 is attached to the aluminum extrusion section 5 and is positioned in the middle of the round tube. Since the LED lamps are usually powered by direct current (DC), so that a switching power supply is usually equipped on the LED fluorescent lamp to convert alternating current into corresponding DC to supply power for the LED fluorescent lamps.

In order to be compatible with the existing mercury fluorescent lamps, the size of the LED fluorescent lamp is close to the size of the mercury fluorescent lamps as far as possible. For example, the diameter of the fluorescent lamp is about 30 millimeter (mm), so the LED fluorescent lamp is also designed according to this standard with the diameter of 30 mm The LED fluorescent lamp minus the housing and the middle interlayer is a semicircular receiving space with the height of about 10 mm, where the switching power supply is received within the semicircular receiving space. The transformer of the present invention has a small size and high power, which can be better applied for the switching power supply of the LED fluorescent lamp.

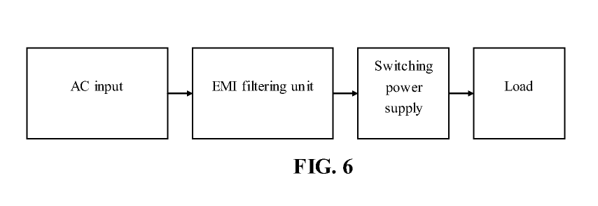

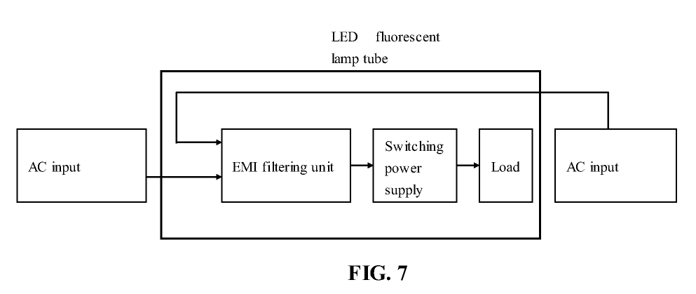

The small space is just a difficult point of the switching power supply, on the other hand, electromagnetic compatibility design of the switching power supply is another difficult point. FIG. 6 is a structural schematic view of a common switching power supply. For the common switching power supply, the AC is input to the EMI filtering unit of power supply and is processed by the EMI filtering unit, the processed AC is transmitted to the main topological part of the switching power supply, and the AC is converted into the corresponding DC by means of high-frequency switching conversion, and the DC is directly output to the load. Compared to the structural view of the common switching power supply, FIG. 7 is a structural schematic view of a switching power supply applied to the LED fluorescent lamp according to one embodiment of this disclosure.

It should be noted that, in order to replace to the traditional fluorescent lamps, the AC must be input to the fluorescent lamp tube from two ends, so one input line inevitably goes through the switching power supply. Due to the limited space, the input line is close to or contacts the transformer and passes through the fluorescent lamp tube. Thus, the interference generated by the switching power supply, especially the interference generated by the transformer in the high-frequency switching, will bypass the EMI filtering unit of the power supply and directly interfere with the AC input lines. That is why the power supply EMI is so intractable.

At present, the LED fluorescent lamp mostly uses non-isolated power supply, that is, the AC flows through rectifier bridge and is rectified into a corresponding DC with voltage of nearly 400V, and the voltage of the DC is reduced to a stable value through the reduction voltage and constant-current circuit to generate and output a constant current to the LED beads. Since the non-isolated power supply uses fewer components, and the size of each component is small, so the components can be easily placed into the power supply of the LED fluorescent lamp. However, the power supply of this mode has main shortcomings as following: because the power supply is the non-isolated mode, the high voltage from the rectifier bridge will directly go to the LED beads once the switching power supply fails. Furthermore it will result in damaging the LED fluorescent lamp, which is difficult to meet the relevant safety certification, such as Underwriters Laboratories Inc. (UL) which is an independent product certification organization.

The current LED fluorescent lamps can also use isolated power supplies to provide power for the LED beads, but the space within the LED fluorescent lamp for the power supplies is too small. However, such transformers usually have larger volumes, which does not meet the installation requirements and will bring the following problems: if the magnetic core 2 of the transformer has a small size, the transformer cannot provide a large power; if the magnetic core 2 can provide a large power, the transformer with a large size can not be directly placed within the LED fluorescent lamp. Moreover, because the isolated power supply can generate EMI in use due to the limitations of its space and use method, so that many isolated power supplies in the market can not pass the related certifications.

The transformer of the present invention has a small size and can provide a large power, so the transformer can be better applied into the switching power supply of the LED fluorescent lamp. On the other hand, the transformer of the present invention has better electromagnetic compatibility, so that the switching power supply of the LED fluorescent lamp applying the transformer can effectively reduce the EMI of the switching power supply.

Similarly, the LED fluorescent lamp applying the switching power supply can also obtain a better electromagnetic compatibility and effectively reduce the EMI of the switching power supply.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A transformer comprising:
a framework (1) comprising a reel (10);
a magnetic core (2); and
a winding (3), wherein the reel (10) is a hollow column structure with openings at two ends, and lateral walls of the reel (10) extend vertically at the position of the openings at two ends to form an annular slot structure (11); the winding (3) is wound around the annular slot structure (11); the magnetic core (2) is a “ [symbol] ” shaped box structure with openings at two ends and covers the reel (10) and the winding (3) from circumference, and the middle part of the magnetic core (2) is inserted into the hollow reel (10).

2. The transformer as claimed in claim 1, wherein the reel (10) is a flat and hollow structure with openings at two ends.

3. The transformer as claimed in claim 1, wherein the transformer further comprises a plurality of pins (12) fixed on one end of the reel (10), and the pins (12) are extended out of the opening of the magnetic core (2) and are electrically connected to the winding (3).

4. The transformer as claimed in claim 1, wherein the magnetic core (2) comprises two magnets with “E” shaped cross-section, the middle part of one magnet is inserted through one opening of the reel (10), and the middle part of another magnet is inserted through the other opening of the reel (10), and the two middle parts are jointed to each other in the hollow reel (10) to form the magnetic core (2) with a “ [symbol] ” shaped cross-section and with openings at two ends.

5. The transformer as claimed in claim 4, wherein the magnetic core (2) with a “ [symbol] ” shaped box structure and with openings at two ends gradually tightens inwards from the openings at two ends to narrow the area of the openings.

6. The transformer as claimed in any of claims 2-5, wherein the framework (1) is made from insulating materials comprising Bakelite, rubber, plastic, glass, ceramics, glass fiber and nylon.

7. The transformer as claimed in any of claims 2-5, wherein the two magnetic cores (2) are composed of two magnets, and the two magnets are adhered together by filling up adhesion substance or are tied together, and the adhered or tied two magnets are fixed on the framework (1).

8. The transformer as claimed in any of claims 2-5, wherein the winding (3) is bonded together by means of adhesion substance and is wound around the annular slot structure (11).

9. A switching power supply applied to a light emitting diode (LED) fluorescent lamp, the switching power supply is built-in the LED fluorescent lamp, wherein the switching power supply comprises a transformer as claimed in any of claims 1-8.

10. A light emitting diode (LED) fluorescent lamp, wherein the LED fluorescent lamp comprises a switching power supply as claimed in claim 9.
